(19) United States
(12) Patent Application Publication
(10) Pub. No.: US 2014/0176664 A1
(43) Pub. Date: Jun. 26, 2014

(54) PROJECTION APPARATUS WITH VIDEO CONFERENCE FUNCTION AND METHOD OF PERFORMING VIDEO CONFERENCE USING PROJECTION APPARATUS

(71) Applicants: Chia-Chien Wu, Hsin-Chu (TW); Tzu-Shou Kuo, Hsin-Chu (TW)

(72) Inventors: Chia-Chien Wu, Hsin-Chu (TW); Tzu-Shou Kuo, Hsin-Chu (TW)

(73) Assignee: CORETRONIC CORPORATION, Hsin-Chu (TW)

(21) Appl. No.: 14/024,648

(22) Filed: Sep. 12, 2013

(30) Foreign Application Priority Data
Dec. 20, 2012 (TW) 101148809

(51) Int. Cl. H04N 7/15

(52) U.S. Cl. CPC H04N 7/15
USPC 348/14.07

(57) ABSTRACT

A projection apparatus includes a projection module, a network module, a video-audio capturing module, a conference module and a processor. The network module provides a network interface. The video-audio capturing module is configured to capture an image and voice of a local user, and accordingly generates local video-audio data. The conference module provides the video conference function. The processor is electrically connected to the projection module, the network module, the video-audio capturing module and the conference module. When the processor enables the video conference function, the projection apparatus establishes a connection with a remote apparatus through the network interface, in order to receive a remote video-audio data of a remote user from the remote apparatus, and transmit the local video-audio data to the remote apparatus. The projection module projects an image corresponding to the remote video-audio data onto a projection surface.

### CROSS-REFERENCE TO RELATED APPLICATION

This application claims the priority benefit of Taiwan application serial no. 101148809, filed on Dec. 20, 2012. The entirety of the above-mentioned patent application is hereby incorporated by reference herein and made a part of this specification.

### BACKGROUND OF THE DISCLOSURE

1. Field of the Disclosure

The disclosure relates to a projection apparatus and a method of using the projection apparatus, and more particularly to a projection apparatus with a video conference function and a method of performing a video conference using the projection apparatus.

2. Description of Related Art

With rapid progress in communication technologies, people nowadays can communicate with one another no matter how far away they are from each other. Meanwhile, with the popularity of high-bandwidth internet access, a video conference system in which image and voice can be transmitted synchronously has also become mainstream in the development of remote communication methods.

Since a conventional video conference system includes a lot of assemblies such as a video camera, a microphone, and a host, the complicated assembling process usually takes a lot of time when establishing an operation environment for a video conference. On the other hand, since a host of a video conference system may not support the specification of other assemblies such as a video camera or a microphone, the problem of compatibility may emerge.

Besides, a conventional video conference system usually displays the image of a remote user via a display device (such as a TV or a liquid crystal display); however, the image displayed in a display device may be restricted to the size and specification thereof, which also dramatically decreases the portability of a video conference system and makes it hard to be adapted to a conference in which a lot of people participate.

### SUMMARY OF THE DISCLOSURE

The disclosure provides a projection apparatus with a video conference function; the projection apparatus is capable of integrating a video conference function thereinto.

The disclosure provides a method of performing a video conference using a projection apparatus, by which a video conference with a remote apparatus may be directly performed via the projection apparatus.

In order to achieve one or a part of or all of the above advantages or other advantages, an embodiment of the disclosure provides a projection apparatus with a video conference function, including a projection module, a network module, a video-audio capturing module, a conference module, and a processor. The network module provides a network interface. The video-audio capturing module is electrically connected to the network module for capturing the image and voice of a local user, and accordingly generates local video-audio data. The conference module provides the video conference function. The processor is electrically connected to the projection module, the network module, the video-audio capturing module and the conference module. When the processor enables the video conference function of the conference module, the projection apparatus establishes a connection with the remote apparatus via the network interface so as to receive the remote video-audio data of a remote user from the remote apparatus, and transmit the local video-audio data to the remote apparatus, wherein the projection module is controlled by the processor so as to project an image corresponding to the remote video-audio data onto a projection surface.

In an embodiment of the disclosure, the local video-audio data includes local video data and local audio data; the remote video-audio data includes remote video data and remote audio data.

In an embodiment of the disclosure, the projection apparatus further includes an image processing module and an audio processing module. The image processing module is electrically connected to the processor for performing an image processing to at least one of the local video data and remote video data. The audio processing module is electrically connected to the processor for performing audio processing to the remote audio data.

In an embodiment of the disclosure, the projection module projects onto the projection surface according to the remote video data processed by the image processing module.

In an embodiment of the disclosure, the image processing module blends the local video data and the remote video data into an integrated image, and the projection module projects the integrated image onto the projection surface.

In an embodiment of the disclosure, the projection apparatus further includes an audio output module. The audio output module is electrically connected to the audio processing module for transforming the processed remote audio data into a voice output.

In an embodiment of the disclosure, the projection apparatus further includes a video processing module. The video processing module is electrically connected to the network module and the image processing module for transforming the remote video data into a format projectable by the projection apparatus.

In an embodiment of the disclosure, the image processing module is included within the processor.

In an embodiment of the disclosure, the conference module includes a memory, which includes a communication software. The processor enables the video conference function by executing the communication software.

In an embodiment of the disclosure, the projection apparatus further includes a video decompression module and an audio decompression module. The video decompression module is electrically connected to the conference module and the network module for performing the image processing to the remote video data, and outputting the processed remote video data to the conference module. The audio decompression module is electrically connected to the conference module and the network module for performing the audio processing to the remote audio data, and outputting the processed remote audio data to the conference module.

In an embodiment of the disclosure, the video decompression module and the audio decompression module are included within the conference module.

In an embodiment of the disclosure, the projection apparatus further includes a video processing module, a video decompression module, and an audio decompression module. The video processing module is electrically connected to the image processing module. The video decompression module is electrically connected to the video processing module and the network module for performing the image processing to the remote video data, and outputting the processed remote video data to the video processing module. The audio decompression module is electrically connected to the audio processing module and the network module for performing the audio processing to the remote audio data, and outputting the processed remote audio data to the audio processing module.

In an embodiment of the disclosure, a video-audio capturing module includes an image capturing module and an audio capturing module. The image capturing module captures the image of the local user and generates local video data accordingly. For example, the image of the local user may include background images around the local user in the video conference environment. The audio capturing module captures the voice of the local user and generates local audio data accordingly. For example, the voice of the local user may include background voice around the local user in the video conference environment.

In an embodiment of the disclosure, the image capturing module has a field of view of at least 90 degrees.

In an embodiment of the disclosure, the projection apparatus further includes a supplemented light source disposed adjacent to the image capturing module and configured to compensate the light insufficient for the local user.

In an embodiment of the disclosure, the projection apparatus further includes a casing which has a front side, a rear side, and a top side. The projection module of the projection apparatus projects an image beam onto the projection surface, wherein the image capturing module is disposed on one of the rear side and top side of the casing, and an image capturing direction of the image capturing module is opposite to an image projection direction of the projection module.

In an embodiment of the disclosure, the top side of the casing of the projection apparatus has a trench, and the image capturing module is suitable for being accommodated in the trench.

In an embodiment of the disclosure, the projection apparatus further includes an audio processing module, a front side image capturing module, a video-audio recording module, and a storage module. The audio processing module is electrically connected to the processor for performing the audio processing to the remote audio data. The front side image capturing module is configured in the front side of the casing of the projection apparatus and is electrically connected to the processor for capturing an image being projected onto the projection surface. The video-audio recording module is electrically connected to the processor, the front side image capturing module, the audio capturing module, and the audio processing module. The storage module is electrically connected to the video-audio recording module. The video-audio recording module records the image being projected onto the projection surface, the remote audio data, and the local audio data, and stores the image on the projection surface, the remote audio data, and the local audio data in the storage module.

In an embodiment of the disclosure, the projection apparatus further includes a video compression module and an audio compression module. The video compression module is electrically connected to the image capturing module and the network module for performing the image processing to the local video data, and outputting the processed local video data to the network module. The audio compression module is electrically connected to the audio capturing module and the network module for performing the audio processing to the local audio data, and outputting the processed local audio data to the network module.

In an embodiment of the disclosure, the conference module includes a memory which includes a communication software. The processor enables the video conference function by executing the communication software. When the communication software is executed, the projection apparatus is connected to a first server via a network interface for performing an authentication procedure. After the authentication procedure is approved, the communication software provides the local user with a permission to send a request for video conference to the remote user. When the local user sends the request for video conference, the processor enables the video-audio capturing module. When the remote user confirms the request for video conference, the communication software establishes a connection between the projection apparatus and the remote apparatus on the first server. When the remote user confirms the request for video conference, the communication software establishes a connection between the projection apparatus and the remote apparatus on a second server.

In an embodiment of the disclosure, the projection apparatus with the video conference function further includes one of an input apparatus and an on-screen display (OSD) control interface.

In an embodiment of the disclosure, the projection apparatus further includes a video-audio recording module and a storage module, wherein the video-audio recording module is electrically connected to the processor for recording the local audio data and the remote video-audio data, and storing the local audio data and the remote video-audio data in the storage module which is electrically connected to the video-audio recording module.

In an embodiment of the disclosure, the projection apparatus further includes a video-audio recording module and a storage module, wherein the video-audio recording module is electrically connected to the conference module for recording the remote video-audio data and the local video data, and storing the remote video-audio data and the local video data in the storage module which is electrically connected to the video-audio recording module.

In an embodiment of the disclosure, the network interface includes at least one of a wired network interface and a wireless network interface.

In order to achieve one or a part of or all of the above advantages or other advantages, an embodiment of the disclosure provides a method of performing a video conference using a projection apparatus, including the following steps: enabling the video conference function of the projection apparatus; capturing the image and voice of the local user and generating the local video-audio data accordingly; establishing a connection with the remote apparatus via the network interface; receiving the remote video-audio data of the remote user from the remote apparatus and transmitting the local video-audio data to the remote apparatus; and projecting the image corresponding to the remote video-audio data onto the projection surface.

In an embodiment of the disclosure, the steps of capturing the image and voice of the local user and generating the local video-audio data accordingly include: capturing the image of the local user and generating the local video data accordingly, and capturing the voice of the local user and generating the local audio data accordingly.

In an embodiment of the disclosure, the method further includes the following steps: performing the image processing to at least one of the local video data and the remote video data, and performing the audio processing to at least one of the local audio data and the remote audio data.

In an embodiment of the disclosure, the method further includes the following step: projecting the image of the remote user onto the projection surface according to the processed remote video data.

In an embodiment of the disclosure, the method further includes the following step: projecting an integrated image onto the projection surface according to the processed local video data and the remote video data.

In an embodiment of the disclosure, the method further includes the following step: transforming the processed remote audio data into voice output.

In an embodiment of the disclosure, the steps of enabling the video conference function of the projection apparatus include: executing the communication software; connecting to the first server via the network interface; performing the authentication procedure; determining whether the authentication procedure is approved; and when the authentication procedure is approved, providing the local user with the permission to send a request for video conference to the remote user.

In an embodiment of the disclosure, after the authentication procedure is approved, the steps of enabling the video conference function of the projection apparatus further include: determining whether the local user sends the request for video conference; when the local user sends the request for video conference, starting to capture the image and voice of the local user and determining whether the remote user confirms the request for video conference; and when the remote user confirms the request for video conference, establishing the connection between the projection apparatus and the remote apparatus on the first server.

In an embodiment of the disclosure, after the authentication procedure is approved, the steps of enabling the video conference function of the projection apparatus further include: determining whether the local user sends the request for video conference; when the local user sends the request for video conference, starting to capture the image and voice of the local user and determining whether the remote user confirms the request for video conference; and when the remote user confirms the request for video conference, establishing the connection between the projection apparatus and the remote apparatus on the second server.

Based on the aforementioned, the embodiments of the disclosure provide a projection apparatus with a video conference function and a method of performing video conference using the projection apparatus. The projection apparatus is capable of incorporating network and a video-audio capturing function therein so that the local user can perform a video conference with the remote user directly via the projection apparatus. The projection apparatus is capable of establishing an operation environment for the video conference without the complicated accessories-assembling process. Moreover, the displayed image is not restricted to the size and specification of display devices, thereby providing the user with more convenience and mobility.

In addition, in an embodiment of the disclosure, a method of performing a video conference using a projection apparatus is provided, wherein after the video conference function of the projection apparatus is enabled, a video-audio recording is enabled.

In an embodiment of the disclosure, the method further includes the following steps: receiving and recording a remote video-audio data and a local audio data of the remote user transmitted by a network module, and storing the remote video-audio data and the local audio data of the remote user.

In an embodiment of the disclosure, the method further includes the following steps: after receiving an image projected onto the projection surface and captured by the front side image capturing module, the local audio data captured by the audio capturing module, and the remote audio data outputted by the audio processing module, storing the projected image, local audio data and the remote audio data in the storage module.

In an embodiment of the disclosure, the following steps are further included: receiving and recording the local video-audio data of the local user captured by a video-audio capturing module as well as the remote video-audio data of the remote user transmitted by a network module, and storing the local video-audio data and the remote video-audio data.

In order to make the aforementioned features and advantages of the disclosure more comprehensible, embodiments accompanying figures are described in detail below.

### BRIEF DESCRIPTION OF THE DRAWINGS

FIG. 1A is a schematic view of a projection apparatus with a video conference function in an embodiment of the disclosure.

FIG. 1B is a schematic view of a projection apparatus with a video conference function in another embodiment of the disclosure.

FIG. 2A is a schematic view of a process in which a portion of a projection apparatus in an embodiment of the disclosure carries out the transmission of a remote video-audio data.

FIG. 2B is a schematic view of a process in which a portion of a projection apparatus in another embodiment of the disclosure carries out the transmission of a remote video-audio data.

FIG. 2C is a schematic view of a process in which a portion of a projection apparatus in another embodiment of the disclosure carries out the transmission of a local video-audio data.

FIG. 3A is a schematic view of performing a video conference using a projection apparatus in an embodiment of the disclosure.

FIG. 3B is a schematic view of performing a video conference using a projection apparatus in an embodiment of the disclosure.

FIG. 3C is a schematic top view of performing the image capturing by an image module of a projection apparatus in an embodiment of the disclosure.

FIG. 4A is a schematic view of performing the projection of an image using a projection apparatus in an embodiment of the disclosure.

FIG. 4B is a schematic view of performing the projection of another image using a projection apparatus in an embodiment of the disclosure.

FIG. 4C is a schematic view of performing the projection of another image using a projection apparatus in an embodiment of the disclosure.

FIG. 5A is a schematic view of video-audio data transmission by a projection apparatus in an embodiment of the disclosure.

FIG. 5B is a schematic view of video-audio data transmission by a projection apparatus in another embodiment of the disclosure.

FIG. 5C is a schematic view of video-audio data transmission by a projection apparatus in yet another embodiment of the disclosure.

FIG. 6 is a flowchart of the steps in a method of performing a video conference using a projection apparatus in an embodiment of the disclosure.

FIG. 7 is a flowchart of the steps in a method of performing a video conference using a projection apparatus in another embodiment of the disclosure.

FIG. 8 is a flowchart of the steps in a method of performing a video conference using a projection apparatus in yet another embodiment of the disclosure.

FIG. 9 is a flowchart of the steps in a method of performing video-audio recording using a projection apparatus in an embodiment of the disclosure.

### DESCRIPTION OF EMBODIMENTS

It is to be understood that both the foregoing and other detailed descriptions, features and advantages are intended to be described more comprehensively by providing a preferred embodiment accompanied with figures hereinafter. The language used to describe the directions such as up, down, left, right, front, back or the like in the embodiments is defined with reference of the directions in the accompanying drawings, and should be regarded in an illustrative rather than in a restrictive sense. Thus, the language used to describe the directions is not intended to limit the scope of the disclosure.

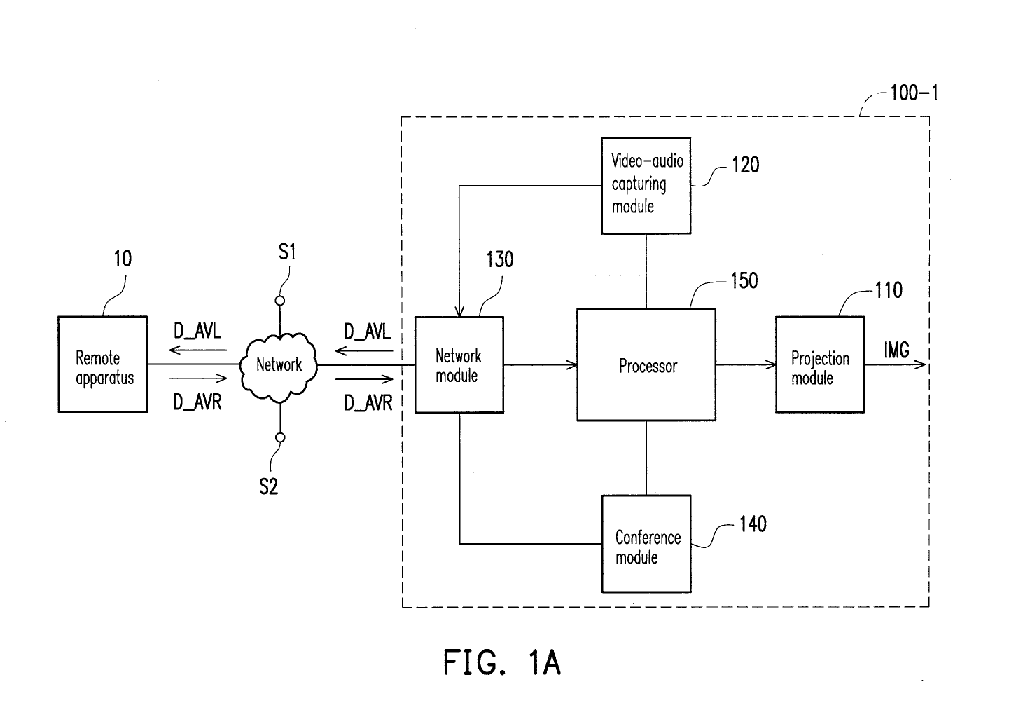

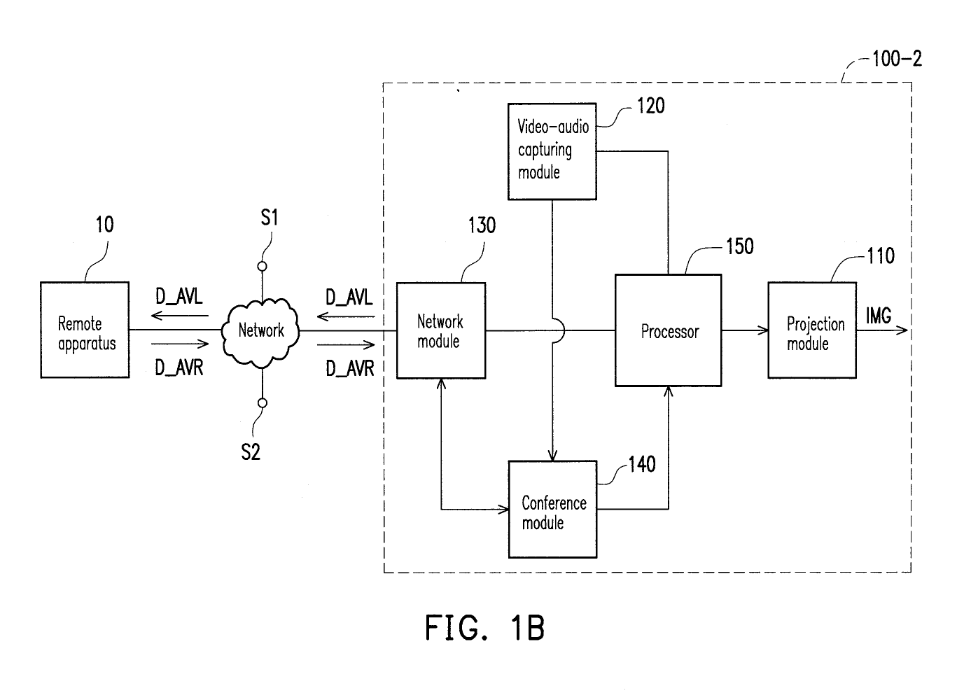

FIG. 1A is a schematic view of a projection apparatus with a video conference function in an embodiment of the disclosure. The projection apparatus is, for example, a projector. Referring to FIG. 1A, the projection apparatus 100-1 includes a projection module 110, a video-audio capturing module 120, a network module 130, a conference module 140, and a processor 150. The projection module 110 projects image(s) onto a projection surface (not shown). And the projection surface is an area suitable for image(s) to be projected thereon such as a projection screen or any smooth wall surface or desk surface. In an embodiment, the projection module 110 implements the function of projecting the image(s) onto the projection surface by a structure (not shown) including a light source, a projection lens and a light valve. For example, a light source in the projection module 110 is capable of providing an illumination beam so that a light valve configured in the transmission path of the illumination beam is capable of transforming the illumination beam into an image beam corresponding to an image IMG. Then, the image IMG is projected onto the projection surface via the projection lens configured in the transmission path of the image beam. The light source is, for example, a solid state light source (such as light emitting diode) or a high intensity discharge (HID) light; however, the disclosure is not limited thereto. The light valve is, for example, a digital micromirror device (DMD), liquid crystal on silicon (LCoS), or a liquid crystal panel; however, the disclosure is not limited thereto.

The video-audio capturing module 120 is electrically connected to the processor 150 and the network module 130, wherein the video-audio capturing module 120 captures the image and voice data of the local user and accordingly generates the local video-audio data D_AVL.

The network module 130 provides a network interface so that the projection apparatus 100-1 is capable of being connected to the Internet or local area network. The network interface may be a wired network interface, e.g., Ethernet, fast Ethernet (or referred to as 100BASE-T), and gigabit Ethernet, or a wireless network interface that supports the wireless communication protocol such as 3G, 4G, long term evolution (LTE) WiFi, 802.11a, 802.11b, 802.11g, 802.11x, Bluetooth, and etc. The network module 130 is, for example, a wired network card, a wireless network card, a wireless network adapter, a 3 G communication chip, or a 4 G communication chip.

The conference module 140 may provide a video conference function, which may be implemented in the form of a software or firmware. In other words, the conference module 140 may be, for example, a memory storing a communication software, or a controller with an embedded firmware; the disclosure is not limited thereto. When the conference module 140 enables the video conference function, the conference module 140 drives the processor 150 so that the processor 150 is capable of controlling the video-audio capturing module 120 to capture the local video-audio data D_AVL to transmit the local video-audio data D_AVL to a remote apparatus 10 via the network module 130.

The processor 150 is electrically connected to the projection module 110, the video-audio capturing module 120, the network module 130, and the conference module 140 to control the operation of each module. The video-audio capturing module 120 may be assembled by an individual video-audio capturing module and an individual audio capturing module respectively. The image capturing module is, for example, a video camera, and the audio capturing module is, for example, a microphone, although the video-audio capturing module 120 may also be a video camera with an image capturing and audio capturing function.

In the embodiment, when the local user controls the projection apparatus 100-1 to enable the video conference function of the conference module 140, the projection apparatus 100-1 may establish a connection with the remote apparatus 10 via a network (may be the Internet or local area network) through the network interface, thereby receiving a remote video-audio data D_AVR of the remote user from the remote apparatus 10, and transmitting the local video-audio data D_AVL to the remote apparatus 10. Therefore, the projection apparatus 100-1 may use the projection module 110 to project the image IMG corresponding to the remote video-audio data D_AVR onto the projection surface according to the received remote video-audio data D_AVR in which the remote user is located at a location where, for example, the remote user cannot see the image IMG being projected onto the projection surface by the local projection apparatus 100-1. The remote apparatus 10 may be a projection apparatus with the same structure as the projection apparatus 100-1, or an electronic apparatus with a network function and a video-audio capturing function such as a conventional desktop computer, a notebook computer, a smart phone, or a smart TV. The type of the remote apparatus 10 provides not limitation to the scope of the disclosure.

FIG. 1B is a schematic view of a projection apparatus in another embodiment of the disclosure. A projection apparatus 100-2 in FIG. 1B and the projection apparatus 100-1 in FIG. 1A are substantially the same; the difference between them lies in that, in the embodiment of FIG. 1B, the local video-audio data D_AVL generated by the image and voice data of the local user and captured by the video-audio capturing module 120 is transmitted to the network module 130 by the conference module 140 and then provided to the remote apparatus 10 via the network. After the remote video-audio data D_AVR is transmitted to the conference module 140 via the network module 130, the image IMG corresponding to the remote video-audio data D_AVR is then projected onto the projection surface via the processor 150 using the projection module 110.

In comparison with a conventional video conference system, in the foregoing embodiments, the video-audio capturing function and network connection function are combined into the projection apparatus 100-1 or 100-2 and controlled by the processor 150, such that the user can establish an operation environment for a video conference system without the complicated accessories-assembling process, and does not need to be concerned about the compatibility problem between each video-audio capturing apparatus (such as a video camera and a microphone) and the video conference system, thereby making it a lot more convenient to be used.

In addition, since the projection apparatuses 100-1 and 100-2 do not need a display device to display images, instead, they are capable of projecting an image onto any suitable projection surfaces, the projection apparatuses 100-1 and 100-2 are smaller and easy to carry in comparison with a conventional smart TV with a video conference function. Moreover, since the size of the projection screen is not restricted to the size of a display device, the projection apparatuses 100-1 and 100-2 may adaptively adjust the size of a projection screen based on the user's need. For example, when there are more people participating in a conference, a larger screen may be projected to be seen clearly by the participants. Therefore, the projection apparatuses 100-1 and 100-2 have greater flexibility for usage in comparison with a conventional video conference system and are less likely to be restricted to the location and space.

In addition, the projection apparatuses 100-1 and 100-2 further include an input apparatus (not shown). The local user can use the input apparatus to operate the projection apparatuses 100-1 and 100-2. The input apparatus may be, for example, a keyboard, a wireless keyboard, or a remote controller that is built in or externally connected to the projection apparatuses 100-1 and 100-2.

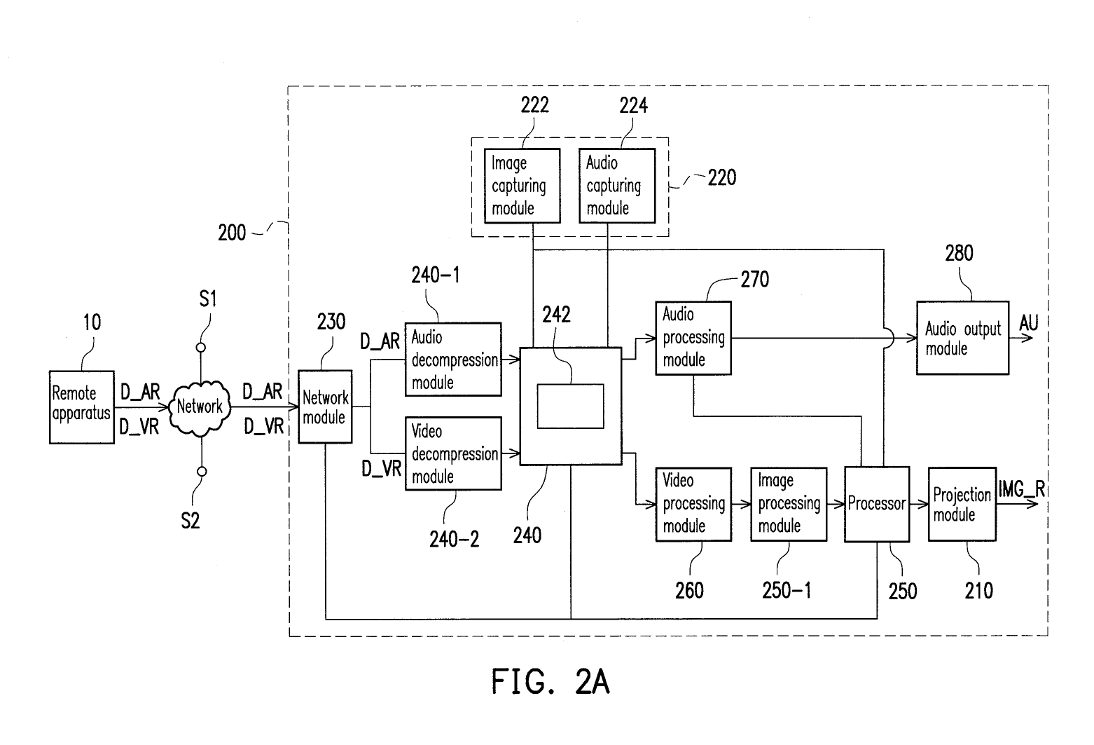

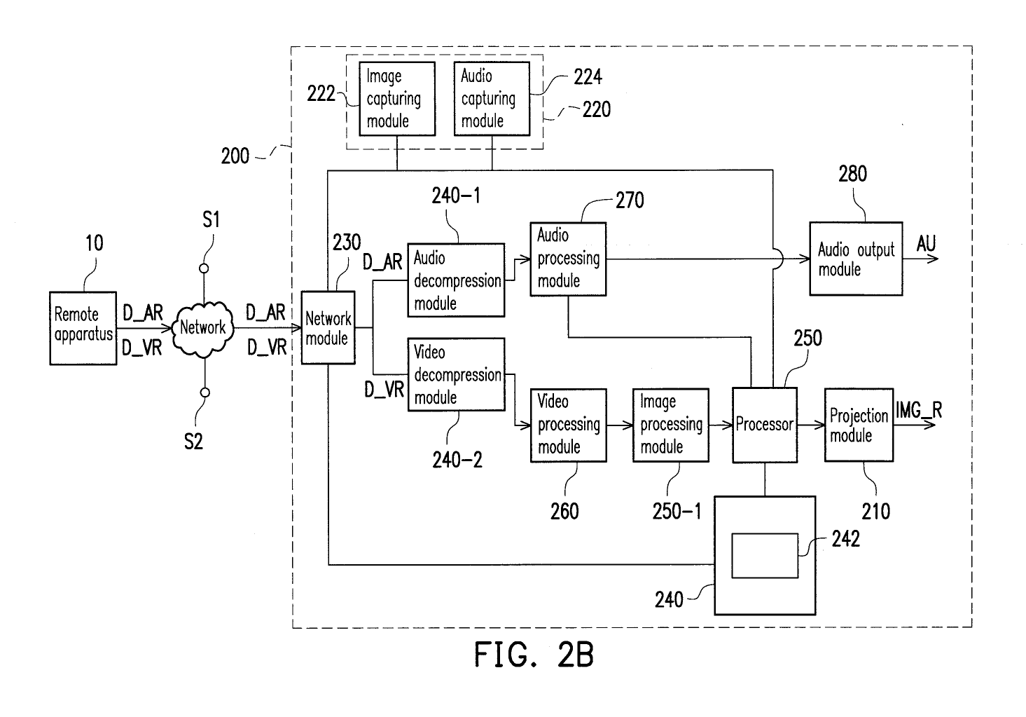

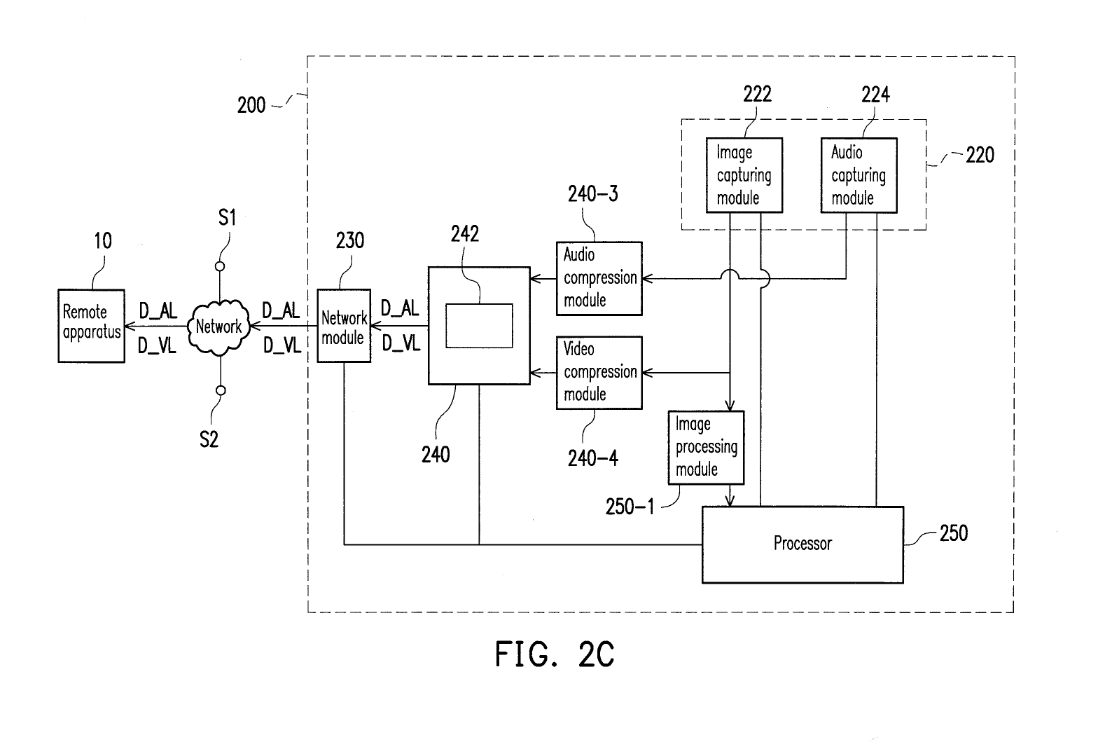

FIG. 2A is a schematic view of a portion of a projection apparatus in an embodiment of the disclosure, describing a transmission process in which the local projection apparatus projects an image and plays voice after receiving the remote video-audio data of the remote user (including a remote audio data D_AR and a remote video data D_VR). Referring to FIG. 2A, the projection apparatus 200 includes a projection module 210, a network module 230, an audio decompression module 240-1, a video decompression module 240-2, a conference module 240, an image processing module 250-1, a processor 250, a video processing module 260, an audio processing module 270, an audio output module 280, and a video-audio capturing module 220. The video-audio capturing module 220 is electrically connected to the processor 250 and the conference module 240. The video-audio capturing module 220 includes an image capturing module 222 and an audio capturing module 224. In the embodiment, the conference module 240 further has a memory in which a communication software 242 is stored for implementation; however, the disclosure is not limited thereto. The projection module 210 and the network module 230 are the same as the foregoing projection module 110 and the network module 130; therefore no further description is incorporated herein.

In the embodiment, for a video conference to be run smoothly, the remote apparatus 10 and the projection apparatus 200 use an image compression technique to reduce the quantity of original video data for which to be transmitted and stored more easily. Therefore, the video decompression module 240-2 in the projection apparatus 200 performs an image processing process in which the image is decompressed, thereby restoring the compressed remote video data D_VR. The image processing may be performed by selecting various video encoding algorithms such as H.261, H.262, H.263, H.264, MJPEG, WMV, MPEG, VP7, VP8, and etc. for image compression according to the requirement for the quality and fluency; the disclosure is not limited thereto. The video decompression module 240-2 such as a video decoder, a video decoding chip or a video decoding circuit may perform decoding/decompression according to the video data corresponding to the compression format. The video processing module 260 is electrically connected to the network module 230 and the processor 250 is configured to perform a video processing to the remote video data D_VR, for example, a format transformation processing which can transform the remote video data D_VR into a format that is projectable by the projection module 210, when receiving the remote video data D_VR; however, the disclosure is not limited to the function. The video processing module 260 is, for example, a video processing chip. In the embodiment, the video processing module 260 is, for example, electrically connected to the conference module 240 and the processor 250.

The remote video data D_VR with a transformed format is transmitted to the image processing module 250-1 that is electrically connected to the video processing module 260. The image processing module 250-1 is, for example, an image processing chip or an image processing circuit adaptable for adjusting the projection size and projection resolution of the remote video data D_VR with a transformed format, or for performing image blending to the remote video data D_VR transmitted by the video processing module 260 and the local video data D_VL, which will be described in details in the following paragraphs. In other embodiments, the image processing module 250-1 has the function of adjusting the size and resolution of the projected image as well as image blending function. In addition, the image processing module 250-1 is not necessarily an independent module, and may be included in the processor 250. That is, the processor 250 may also have the function that the image processing module 250-1 has.

The processor 250 transmits the processed remote video data D_VR to the projection module 210 to project an image IMG_R of the remote user.

Similar to the video decompression module 240-2, the audio decompression module 240-1 is configured to perform an audio processing process in which the audio is decompressed, thereby restoring a compressed remote audio data D_AR. The audio processing may be performed by selecting various audio encoding algorithms such as G.711, G.722, G723, G726, G.728, WMA, AAC, or ILBC, and etc. for audio compression according to the requirement for the voice quality and fluency; the disclosure is not limited thereto. The audio decompression module 240-1, such as an audio decoder, an audio decoding chip, or an audio decoding circuit, is capable of performing decoding/decompression according to the audio data corresponding to the compression format. The audio processing module 270, such as an audio processing chip, is electrically connected to the processor 250 for performing audio processing, such as adjusting the volume of voice output and voice quality, to the remote audio data D_AR when receiving the remote audio data D_AR; the disclosure is not limited thereto. The audio output module 280 is electrically connected to the audio processing module 270 for transforming the processed remote audio data D_AR into a voice output AU corresponding to the voice of the remote user USR_R. Specifically, the audio output module 280 may be, for example, a speaker built in or externally connected to the projection apparatus 200.

In another embodiment of the disclosure, the audio decompression module 240-1 and the video decompression module 240-2 may be disposed in the conference module 240. The network module 230 may directly transmit the remote audio data D_AR and the remote video data D_VR to the conference module 240 having an audio and video decompression function for performing decompression.

FIG. 2B is a schematic view of a portion of a projection apparatus in an embodiment of the disclosure and is similar to FIG. 2A; the difference between them lies in that the video decompression module 240-2 is electrically connected to the network module 230 and the video processing module 260. The audio decompression module 240-1 is electrically connected to the network module 230 and the audio processing module 270. The processor 250 is electrically connected to the conference module 240. The projection apparatus 200 receives the remote video data D_VR and the remote audio D_AR via the network module 230 after the conference module 240 is enabled. The remote video data D_VR is transmitted to the video decompression module 240-2, after processed with decompression, and then transmitted to the video processing module 260 to perform the image processing, for example, transformed the remote video data D_VR into the format projectable by the projection apparatus 200; thereafter, the remote video data D_VR is again transmitted to the image processing module 250-1 for performing image processing such as adjusting the projection size and resolution of the remote video data D_VR with a transformed format or other image processing, and finally the image IMG_R corresponding to the remote video-audio data D_AVR is projected onto the projection surface via the processor 250 using the projection module 210. The remote audio data D_AR is transmitted to the audio decompression module 240-1, after being processed with decompression, and then transmitted to the audio processing module 270 for performing the audio processing, such as adjusting the volume and quality of the voice output. In addition, the video-audio capturing module 220 is electrically connected to the processor 250 and network module 230. The description regarding the function and structure of the audio decompression module 240-1, video decompression module 240-2, video processing module 260, and audio processing module 270 are already provided in the previous paragraphs, and therefore no further description is incorporated herein.

It should be noted that although it is not shown in FIG. 2A or FIG. 2B, in other embodiments, the audio decompression module 240-1 and the audio processing module 270 may be manufactured into a single module/circuit or chip via the manner of an integrated circuit manufacturing process; the video decompression module 240-2 and the video processing module 260 may be manufactured into a single module/circuit or chip, too.

FIG. 2C is a schematic view of a portion of a projection apparatus in an embodiment of the disclosure, describing a process which the local projection apparatus 200 transmits the local video data D_VL and the local audio data D_AL to the remote apparatus 10 via the network module 230 after the local projection apparatus 200 generates a local video data D_VL and a local audio data D_AL using the video-audio capturing module 220. In the video-audio capturing module 220, the image capturing module 222 and the audio capturing module 224 respectively capture the image and voice of the local user, and respectively generate the local video data D_VL and the local audio data D_AL accordingly. In an embodiment, the image capturing module 222 captures the image of the local user and then transmits the image of the local user to the image processor 250-1 for performing image blending with the remote video data D_VR. The specific description is incorporated in the following paragraphs.

The scope of a field of view of the image capturing module 222 is at least 90 degrees. In an embodiment, the image capturing module 222 may capture an all-view image of the local user by using a video camera with an all-view image capturing function; alternatively, the image capturing module 222 may include an image processing software which may compose the image captured by the image capturing module 222 into an all-view image via a software processing; the disclosure is not limited thereto. On the other hand, the audio capturing module 224 may be, for example, a microphone built in or externally connected to the projection apparatus 200. The microphone is capable of transmitting the local audio data D_AL to an audio compression module 240-3.

In addition, a video compression module 240-4 is electrically connected to the image capturing module 222 and the network module 230. The video compression module 240-4 is, for example, a video encoder, a video encoding chip, or a video encoding circuit adaptable for performing the format transformation to the local video data D_VL so as to comply with the video format corresponding to the remote apparatus 10, the encoding algorithm for which is the same as that described above and no further relevant description is incorporated herein. Specifically, the video compression module 240-4 is configured between the image capturing module 222 and the conference module 240. The video compression module 240-4 is configured to execute the image processing process in which the image is compressed. The video compression module 240-4 outputs the compressed local video data D_VL to the network module 230 when the video conference function is enabled, and transmits the compressed local video data D_VL to the remote apparatus 10 via the network interface 230.

Similar to the video compression module 240-4, the audio compression module 240-3 is electrically connected to the audio capturing module 224 and the network module 230. The audio compression module 240-3 is, for example, an audio encoder, an audio encoding chip, or an audio encoding circuit for transforming the audio format of the local audio data D_AL so at to comply with the audio format corresponding to the remote apparatus 10, the encoding algorithm for which is the same as that described above and no further relevant description is incorporated herein. Specifically, the audio compression module 240-3 is configured between the audio capturing module 224 and the conference module 240. The audio compression module 240-3 is configured to execute the audio processing process in which the audio is compressed. The audio compression module 240-3 outputs the compressed local audio data D_AL to the network module 230 when the video conference function is enabled, and transmits the compressed local audio data D_AL to the remote apparatus 10 via the network interface.

On the other hand, the video compression module 240-4 and the audio compression module 240-3 may be combined with the conference module 240; that is, the video compression module 240-4 and the audio compression module 240-3 are included in the conference module 240, thereby simplifying the circuit design which is therefore relatively simpler.

In the foregoing projection apparatus 200, the various video processing and audio processing process may be adopted for processing the local video-audio data D-VL and D_AL as well as the remote video-audio data D_VR and D_AR according to the design requirement. The compression/decompression processing process for the video data and audio data described herein is simply as an example; the disclosure is not limited thereto.

In the embodiment, the local user can operate the projection apparatus 200 so that the processor 250 executes the communication software 240 to enable the video conference function. The communication software 242 may be an instant communication software such as Skype, MSN, Yahoo messenger, ICQ messenger, Google Talk, or etc.; the disclosure is not limited thereto. Specifically, the projection apparatus 200 further includes an input apparatus (not shown), by which the local user can operate the projection apparatus 200. The input apparatus may be, for example, a keyboard, a wireless keyboard, or a remote controller embedded in or externally connected to the projection apparatus 200. In addition, the projection apparatus 200 further includes an on-screen display (OSD) interface (not shown). The projection apparatus 200 is capable of projecting the OSD interface onto the projection surface such that the local user can use the input apparatus to operate the OSD interface, thereby adjusting the image setting (such as adjusting the size and contrast of the projection screen), adjusting the audio setting (such as adjusting the volume of the voice output) and executing the communication software 242. The OSD interface may be in the form of a menu or a keyboard according to the operation requirement of the local user; the disclosure is not limited thereto.

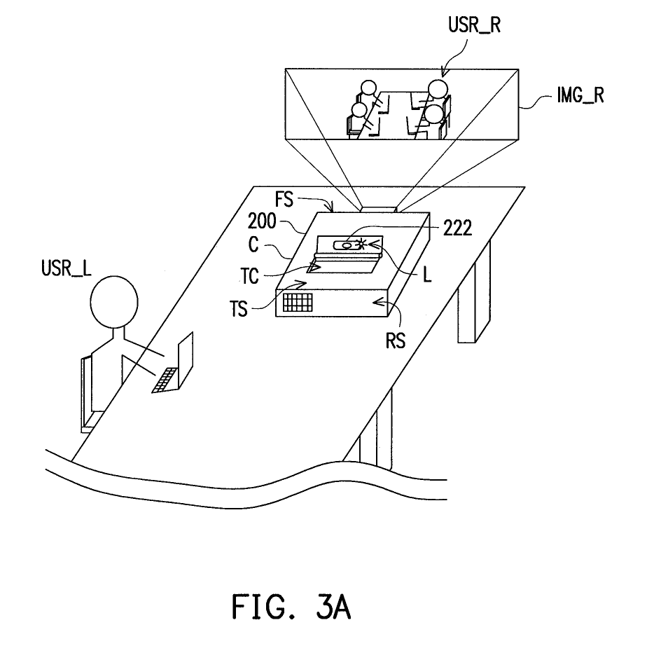

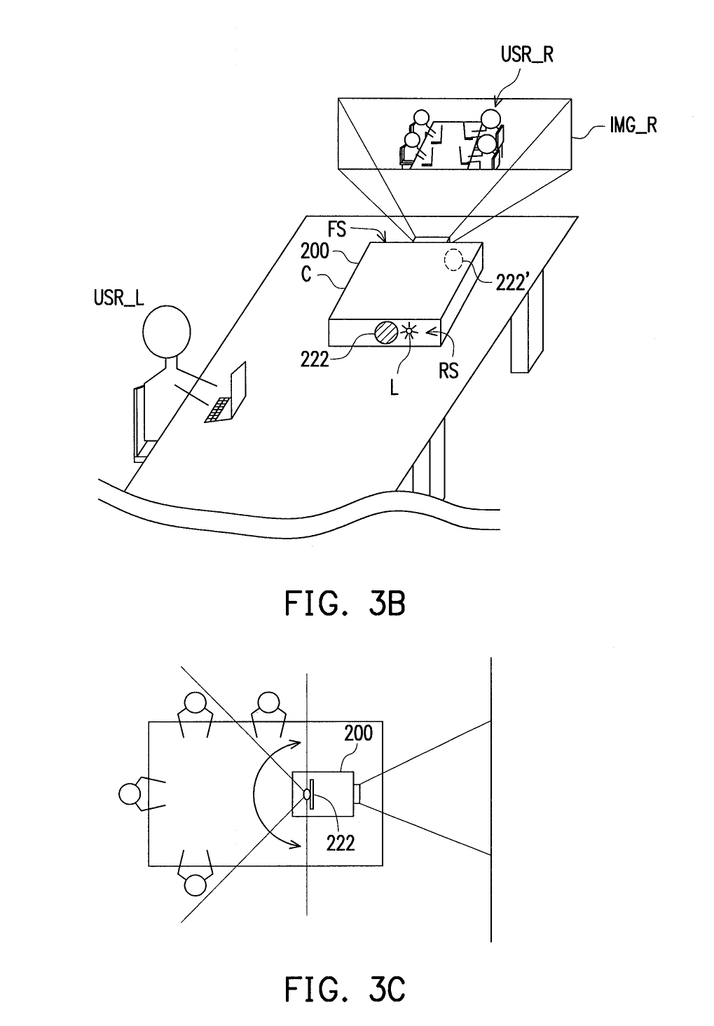

Referring to FIGS. 2A, 2C and 3A, FIG. 3A is a schematic view of performing a video conference using a projection apparatus in FIGS. 2A and 2C. When the communication software 242 is executed, the projection apparatus 200 is connected to a first server S1 for performing an authentication procedure via the network interface (for example, the local user is requested to enter an account and a password) to authenticate the identity of a local user USR_L. The local user USR_L may use the input apparatus and/or the OSD interface of the projection apparatus 200 to enter a corresponding information for performing the authentication procedure. When the authentication procedure of the local user USR_L is approved, the communication software 242 allows the projection apparatus 200 to log onto the first server S1, and provides the local user with permission to request for video conference. At this time, the local user can send a request for video conference to any one of the remote users who is online.

In the embodiment, the processor 250 enables the video-audio capturing module 220 when the local user USR_L sends a request for video conference to a remote user USR_R, so that the video-audio capturing module 220 starts to capture the image and voice of the local user USR_L, and the processor 250 or the communication software 242 will keep determining whether the remote user USR_R confirms the request for video conference sent by the local user USR_L. When the remote user USR_R confirms the request for video conference, the communication software 242 establishes a connection between the projection apparatus 200 and the remote apparatus 10 on the first server S1 to receive the remote video data D_VR and remote audio data D_AR of the remote user USR_R, and transmit the local video data D_VL and the local audio data D_AL to the remote apparatus 10.

After the connection between the projection apparatus 200 and the remote apparatus 10 is established, the video processing module 260, the image processing module 250-1, and the audio processing module 270 respectively perform the image processing and audio processing to the remote video data D_VR and the remote audio data D_AR, such that the projection module 210 projects the image IMG_R of the remote user USR_R onto the projection surface according to the processed remote video data D_VR, and transforms the processed remote audio data D_AR into the voice output AU of the remote user USR_R. On the other hand, the remote apparatus 10 may also output the image and voice of the local user USR_L synchronously on the remote apparatus 10 according to the received local video data D_VL and the local audio data D_AL.

The connection between the projection apparatus 200 and the remote apparatus 10 is not restrictively established on the first server S1. In other embodiments, the projection apparatus 200 and the remote apparatus 10 may also establish a connection on a second server S2 that is different from the first server S1 when the remote apparatus 10 confirms the request for video conference, so that the second server S2 with higher capability may be employed to process large quantity of data transmission. In addition, the first server S1 and the second server S2 may be combined into a super server in one embodiment so that the projection apparatus 200 is capable of performing the authentication procedure on the super server as well as establishing a connection to the remote apparatus 10; the disclosure is not limited thereto.

In the embodiment, any data transmission between the projection apparatus 200 and the remote apparatus 10 may be processed via the communication software 242 so that the video conference can be performed through an interface supported by the communication software 242. In another exemplary embodiment, after the projection apparatus 200 establishes the connection to the remote apparatus 10 via the network module 230 through the communication software 242, the projection apparatus 200 is capable of performing data transmission and exchange with the remote apparatus 10 directly by the network module 230 based on the established connection without the communication software 242. In other words, after the projection apparatus 200 successfully establishes the connection to the remote apparatus 10, the projection apparatus 200 may perform the video conference through the interface supported by the communication software 242, or stop executing the communication software 242 and change to perform the video conference by the transmission interface according to the design requirement, the disclosure is not limited thereto.

From the perspective of the hardware configuration, as shown in FIG. 3A, the projection apparatus 200 includes a casing C, and each device in the projection apparatus 200 may be configured in or on the casing C. The casing C has a front side FS, a rear side RS, and a top side TS. Specifically, a projection lens of the projection module 210 is disposed at the front side FS of the casing C, and the image capturing module 222 is disposed at the top side TS of the casing C, but the disclosure is not limited thereto. For example, the image capturing module 222 may also be disposed at the rear side RS of the casing C. With regard to the image capturing module 222 being disposed in the casing C, a trench TC suitable for accommodating the image capturing module 222 is disposed at the top side TS of the casing C. For example, the image capturing module 222 is disposed on a board surface to be disposed in the top side TS of the projector casing C using a pivot, so that the image capturing module 222 can be turned up or accommodated by the twisted spring. Meanwhile, the turned-up angle may be adjusted depending on the user's setting. The audio output module 280, such as an amplifier or a speaker, and the audio capturing module 224, such as a microphone, may all be disposed at any side (not shown) of the casing C. When using a conventional projector, since the user generally sits relative to the rear side RS of the projector, in a preferable embodiment, the audio output module 280 and the audio capturing module 224 are disposed at the rear side RS of the projector casing C to achieve a better audio-amplifying and audio-receiving effect. In addition, according to the hardware configuration manner, an image projection direction of the projection module 210 (i.e. the direction from the projection apparatus 200 to the remote user image IMG_R) may be opposite to an image capturing direction of the image capturing module 222 (i.e. the direction from the image capturing apparatus 222 to the local user USR_L).

Additionally, in an embodiment, the projection apparatus 200 may include a supplemented light source L. Specifically, the processor 250 may enable the supplemented light source L when detecting that the ambient light source is insufficient so that the supplemented light source L is used to compensate for the light insufficient to the local user USR_L, thereby avoiding the image of the local user USR_L to be over dark. The supplemented light source L may be, for example, a light source comprises light emitting diode (LED), and the supplemented light source L may be disposed adjacent to the image capturing module 222, or be embedded in or externally connected to the rear side RS of the casing C; however, the disclosure is not limited thereto.

FIG. 3B is a hardware configuration of a projection apparatus in another embodiment; the difference between FIGS. 3B and 3A lies in that the image capturing module 222 is disposed at the rear side RS of the casing C of the projection apparatus 200 to clearly capture the image of the local user USR_L at close distance, for example, including the action and facial expression of the local user USR_L and the external ambient image around the local user USR_L. Similarly, the supplemented light source L may be disposed adjacent to the image capturing module 222. The processor 250 may enable the supplemented light source L when detecting that the ambient light source is insufficient so that the supplemented light source L may be employed to compensate for the light insufficient for the local user USR_L.

FIG. 3C is a schematic top view of performing the image capturing by an image capturing module of a projection apparatus in an embodiment of the disclosure. The image capturing module 222 is, for example, a video camera built in or externally connected to the projection apparatus 200. The video camera may use a wide-angle lens (such as a fish-eye lens) or an all-view lens to provide a better scope of the field of view; for example, the scope of the field of view is at least 90 degrees (for example, a scope of the field of view is 0-180 degrees), thereby providing a broader image capturing scope. In addition, in order to obtain the foregoing scope of the field of view, a plurality of video cameras may be employed to achieve the purpose.

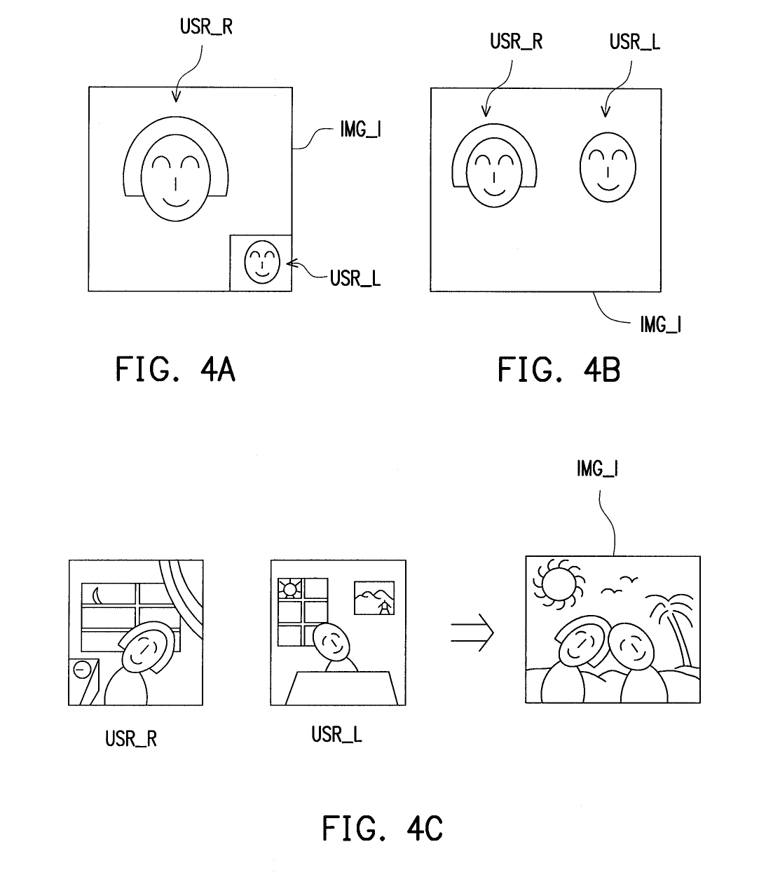

FIGS. 4A-4C are schematic views of a projection apparatus in an embodiment of the disclosure performing projection of an image. Referring to FIGS. 2A, 2C, 4A, and 4B, the image processing module 250-1 is capable of performing an image integration processing to the received remote video data D_VR and the local video data D_VL captured by the image capturing module 222, such that the projection module 210 projects an integrated image IMG_I which includes both the local user USR_L and the remote user USR_R. In the embodiment, the local user USR_L can select the image output type of the projection apparatus 200 depending on the local user's requirement, and set the display format of the integrated image IMG_I using the input apparatus and/or the OSD interface. For example, the local user USR_L can select to output the image (such as IMG_R) of the remote user or the integrated image IMG_I depending on the requirement.

On the other hand, when the projection apparatus 200 outputs the integrated image IMG_I, the local user USR_L can use the input apparatus and/or the on OSD interface to adjust the image proportion and position of the remote user USR_R and the local user USR_L. Referring to FIGS. 4A and 4B, according to the local user's predetermined setting, the way in which the integrated image IMG_I is displayed is adjusted, for example, to be displayed as picture-in-picture or in half. An embodiment of the disclosure uses the image processing module 250-1 such as an image processing chip or image processing circuit to execute the image blending technique so that a seam does not emerge in the integrated image IMG_I of the local user USR_L and the remote user USR_R, such that the integrated image looks nicer and clearer. Moreover, the projection apparatus 200 projects the integrated image IMG_I, allowing the local user USR_L to feel like being in the same place as the remote user USR_R or to feel like having a face-to-face conference with the remote user USR_R when conducting a video conference with the remote user USR_R.

Referring to FIG. 4C, in another embodiment, the image of the remote user USR_R and the image of the local user USR_L may be further blended and integrated. Furthermore, the image processing module 250-1 may be employed to further modify and adjust the background according to the setting of the local user USR_L to achieve the image display requirement of the local user USR_L.

In yet another embodiment, the image processing module 250-1 may be combined with the processor 250 so that the local user USR_L and the remote user USR_R may also perform image blending via the processor 250.

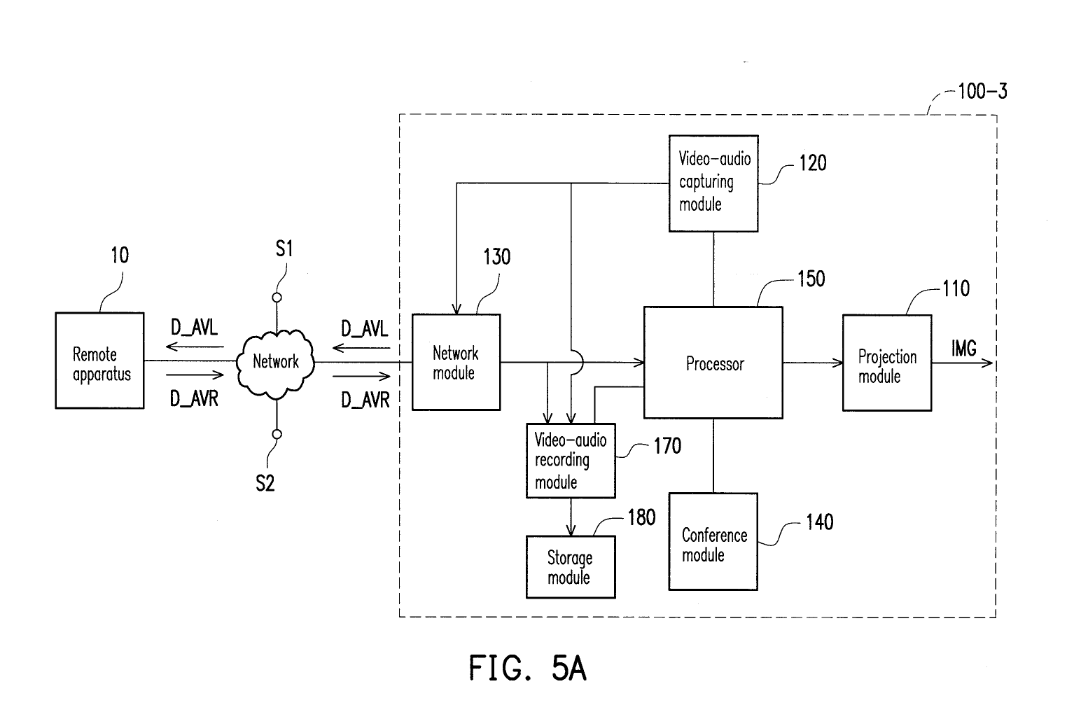

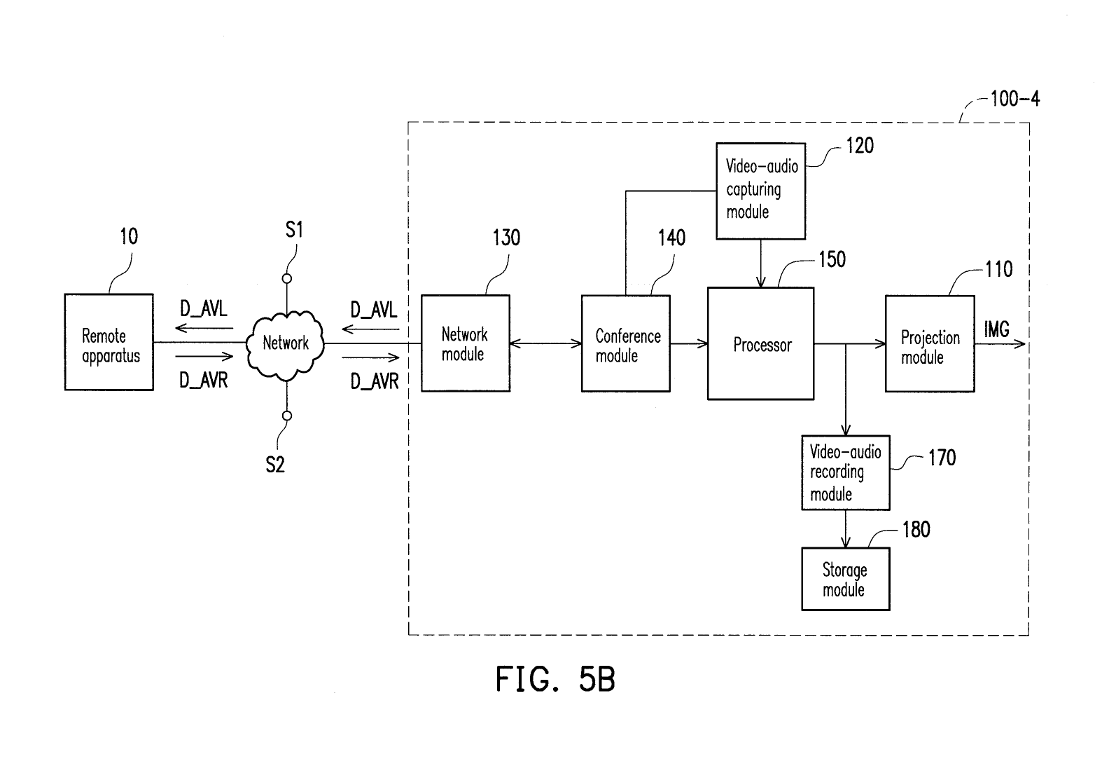

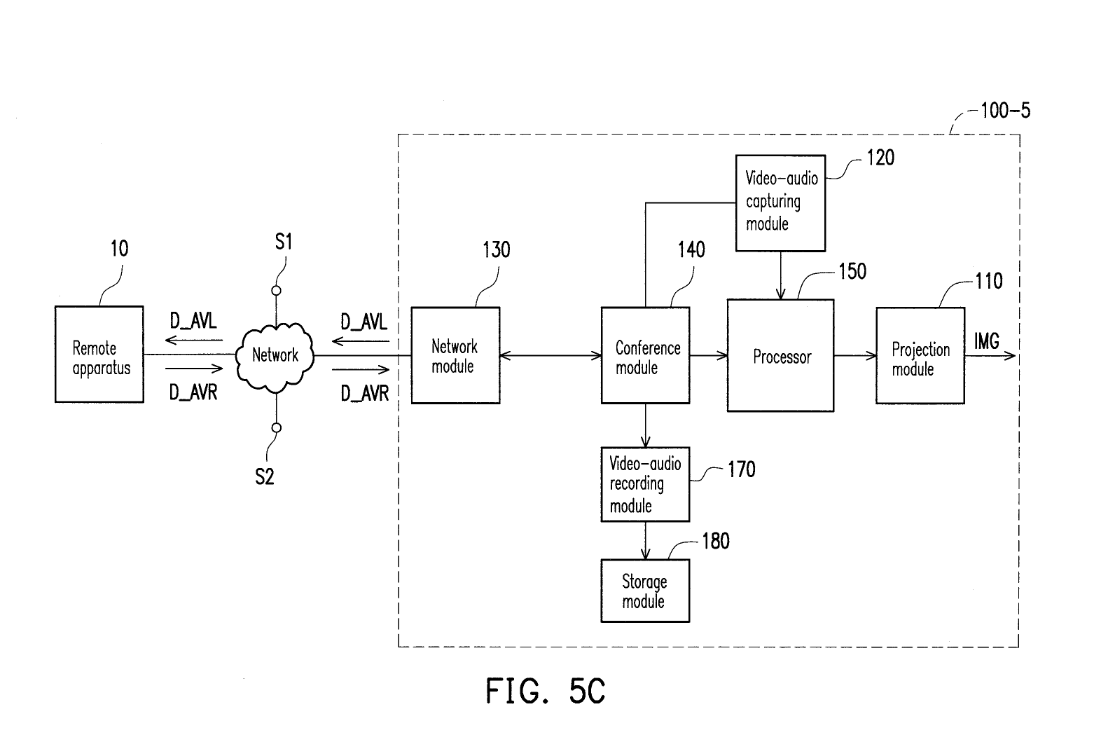

FIG. 5A is a schematic view of video-audio data transmission by a projection apparatus in an embodiment of the disclosure. The difference between a projection apparatus 100-3 in FIG. 5A and the projection apparatus 100-1 in FIG. 1A lies in that the projection apparatus 100-3 further includes a video-audio recording module 170 and a storage module 180. The video-audio capturing module 120 is electrically connected to the network module 130 and the video-audio recording module 170. When the conference module 140 enables the video conference function, the video-audio recording module 170, such as a video-audio recording chip, a chip including a video-audio recording firmware or software, is enabled via the processor 150 so that the local video-audio data D_AVL and the remote video data D_AVR captured by the video-audio capturing module 120 may be further recorded and stored in the storage module 180 via the video-audio recording module 170. The storage module 180 may be a random access memory (RAM) disposed in the projection apparatus 100-3 or other common storage apparatuses outputted from an input/output port (I/O port) to a USB drive and a memory card.

FIG. 5B is a schematic view of video-audio data transmission by a projection apparatus in another embodiment of the disclosure. In the embodiment, a projection apparatus 100-4 enables the video-audio recording module 170 via the processor 150 such that the image IMG generated by image blending using the local video-audio data D_AVL and the remote video-audio data D_AVR captured by the video-audio capturing module 120 is recorded by the video-audio recording module 170 and then stored in the storage module 180.

In addition, FIG. 5C is a schematic view of video-audio data transmission by a projection apparatus in yet another embodiment of the disclosure. In the embodiment, the remote video-audio data D_AVR provided by the remote apparatus 10 is transmitted to the conference module 140 via the network module 130; thereafter, since the conference module 140 of a projection apparatus 100-5 is electrically connected to the video-audio recording module 170, the remote video-audio data D_AVR is recorded via the video-audio recording module 170 through the conference module 140 and then stored in the storage module 180. In other embodiments, through the conference module 140, the remote video-audio data D_AVR and the local video-audio data D_AVL captured by the video-audio capturing module 120 are recorded via the video-audio recording module 170 and then stored in the storage module 180. It should be understood that, in the embodiments of FIG. 5A, 5B, or 5C, the video-audio recording module 170 may also record the remote video-audio data D_AVR and the local audio data D_AL only.

In another embodiment of the disclosure, the video-audio recording module 170 may also be combined with the conference module 140 to be in the same module/circuit/chip design, but the disclosure is not limited thereto. In yet another embodiment, the communication software 242 also has a function that a video-audio recording software has.

Moreover, in another embodiment of the disclosure, a front side photograph module 222′ is disposed at the front side FS of the projection apparatus 200 for capturing an image projected onto the projection surface (such as the remote user image IMG_R or the integrated image IMG_I). The front side photograph module 222′ is electrically connected to the processor 250, and the front side photograph module 222′, audio processing module 270, and the audio capturing module 224 are electrically connected to the audio recording module 170; therefore, through the front side photograph module 222′, the projection apparatus 200 may record the remote user image IMG_R (or integrated image IMG_I) projected onto the screen, the voice of the local user recorded by the audio capturing module 224, and the remote audio data processed by the audio processing module 270 via the video-audio recording module 170 and then store them in the storage module 180.

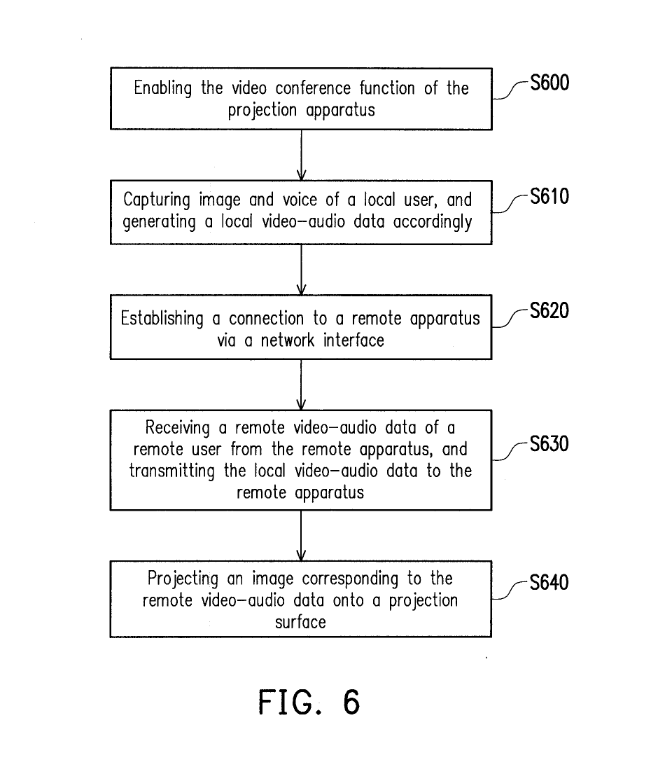

FIG. 6 is a flowchart of the steps in a method of performing a video conference using a projection apparatus in an embodiment of the disclosure. The method is adaptable for the projection apparatuses 100-1, 100-2, and 200 described in the embodiments in FIGS. 1A, 1B, and 2A-2C. Referring to FIG. 6, first of all, the video conference function of the projection apparatus is enabled (step S600). Thereafter, the image and voice of the local user are captured and the local video-audio data is generated accordingly (step S610). Next, the connection to the remote apparatus (such as 10) is established through the network interface (step S620) so that the remote video-audio data of the remote user is received from the remote apparatus, and then the local video-audio data is transmitted to the remote apparatus (step S630). After the remote video-audio data is received, the image corresponding to the remote video-audio data is projected onto the projection surface (step S640).

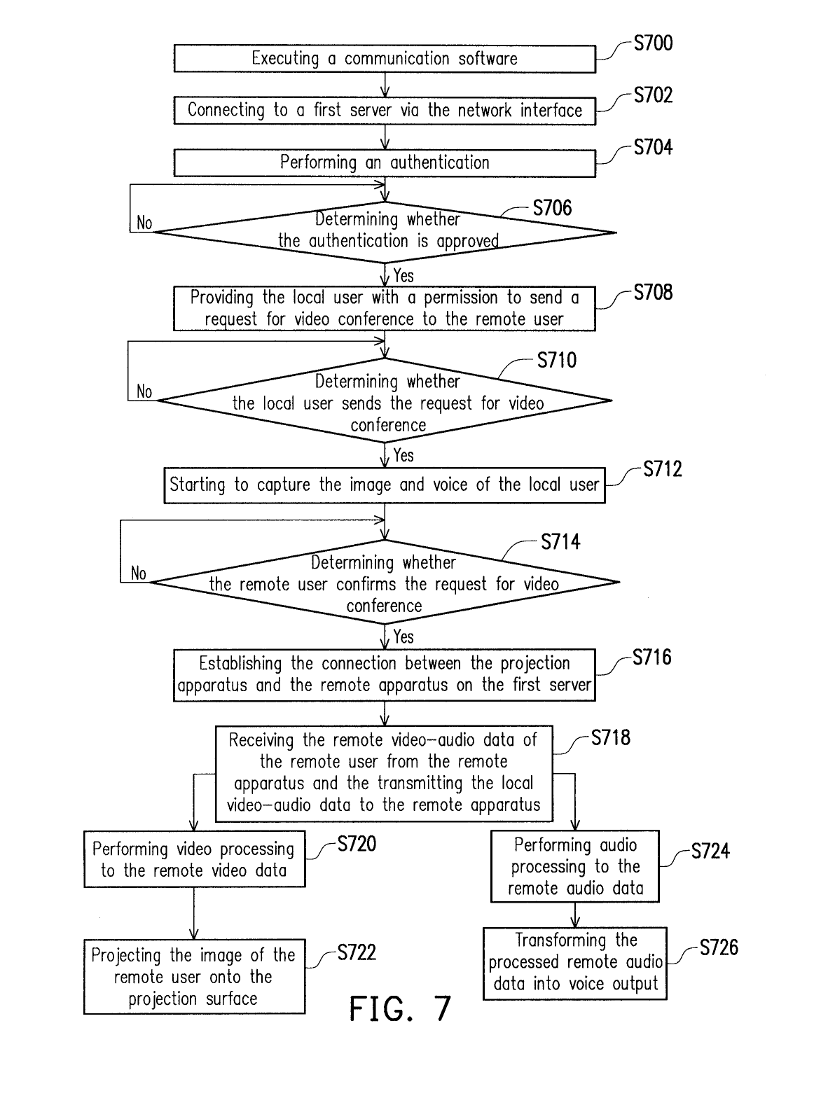

FIG. 7 is a flowchart of the steps in a method of performing a video conference using a projection apparatus in another embodiment of the disclosure. The method is adaptable for the projection apparatuses 100-1, 100-2, and 200 described in the embodiments in FIGS. 1A, 1B, and 2A-2C. Referring to FIG. 7, first of all, the local user may execute the communication software (step S700) to be connected to the first server via the network interface provided by the network module (such as 230) (step S702). Subsequently, the communication software requests the local user to perform an authentication procedure (step S704) and determines whether the authentication procedure is approved (step S706). The communication software further provides the local user with the permission to send a request for video conference to the remote user when the authentication procedure of the local user is approved (step S708), and determines whether the local user sends the request for video conference (step S710). When the local user sends a request for video conference, the projection apparatus starts to capture the image and voice of the local user (step S712) to generate the local video-audio data; the communication software determines whether the remote user confirms the request for video conference (step S714). After the remote user confirms the request for video conference, the communication software establishes a connection between the projection apparatus and the remote apparatus on the first server or another second server (step S716).

After the connection is established, the projection apparatus receives the remote video-audio data of the remote user from the remote apparatus (including the remote video data and the remote audio data), and then transmit the local video-audio data (including the local video data and the local audio data) to the remote apparatus (step S718). Before transmitting the local video data and the local audio data to the remote apparatus, the projection apparatus may perform the image compression and audio compression processing process to the local video data and the local audio data, thereby reducing the quantity of data to be transmitted.

On the other hand, after the projection apparatus receives the remote video data, an image processing is performed to decompress the remote video data (step S720), and the image of the remote user is projected onto the projection surface according to the processed remote video data (step S722). Similarly, an audio processing is performed to decompress the remote audio data (step S724), and the processed remote audio data is transformed into a voice output (step S726).

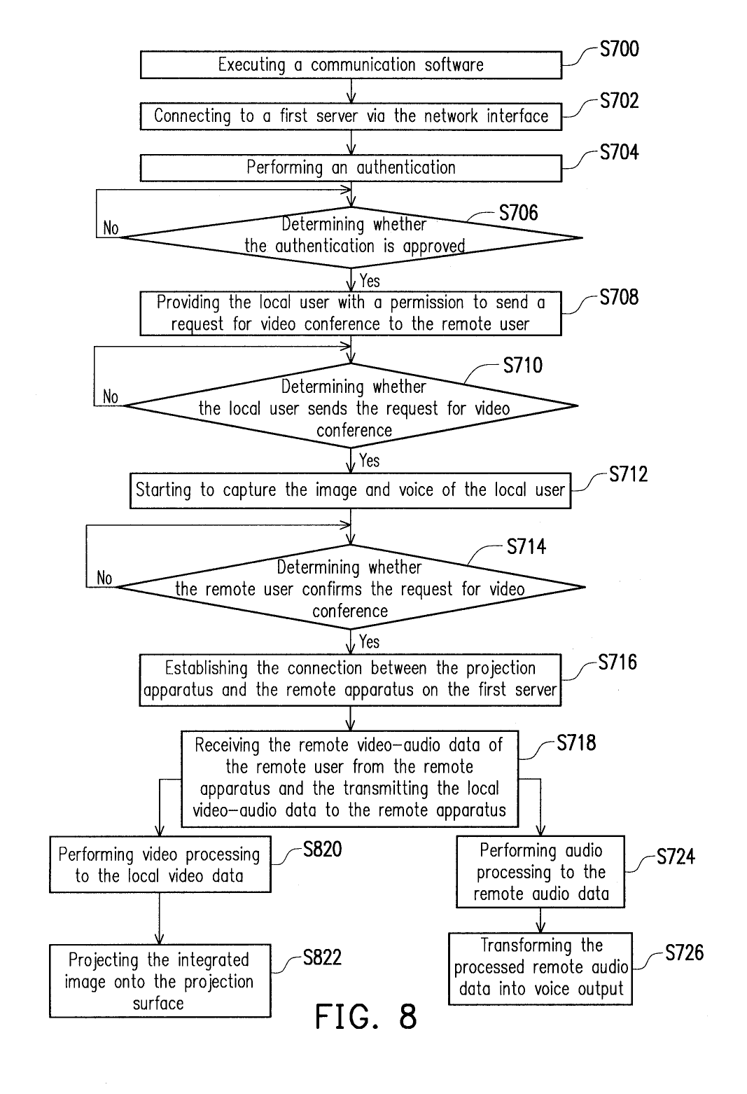

FIG. 8 is a flowchart of the steps in a method of performing a video conference using a projection apparatus in yet another embodiment of the disclosure. The method is adaptable for the projection apparatuses 100-1, 100-2, and 200 described in the embodiments in FIGS. 1A, 1B, and 2A-2C. Referring to FIG. 8, in the embodiment, steps S700-S718 as well as steps S724 and S726 are substantially the same as that in the embodiment in FIG. 7; therefore, no further relevant description is incorporated herein. The difference between the embodiment and that in FIG. 7 lies in that, after step S718, the projection apparatus performs image integration processing to the local video data and the received remote video data (step S820), such that the projection apparatus projects the integrated image that includes the image of the local user and the image of the remote user onto the projection surface according to the processed local video data and the remote video data (step S822).

The methods described in FIGS. 6-8 can be fully supported and taught by the illustration of foregoing figures; therefore the similar or the same features are not further described hereinafter.

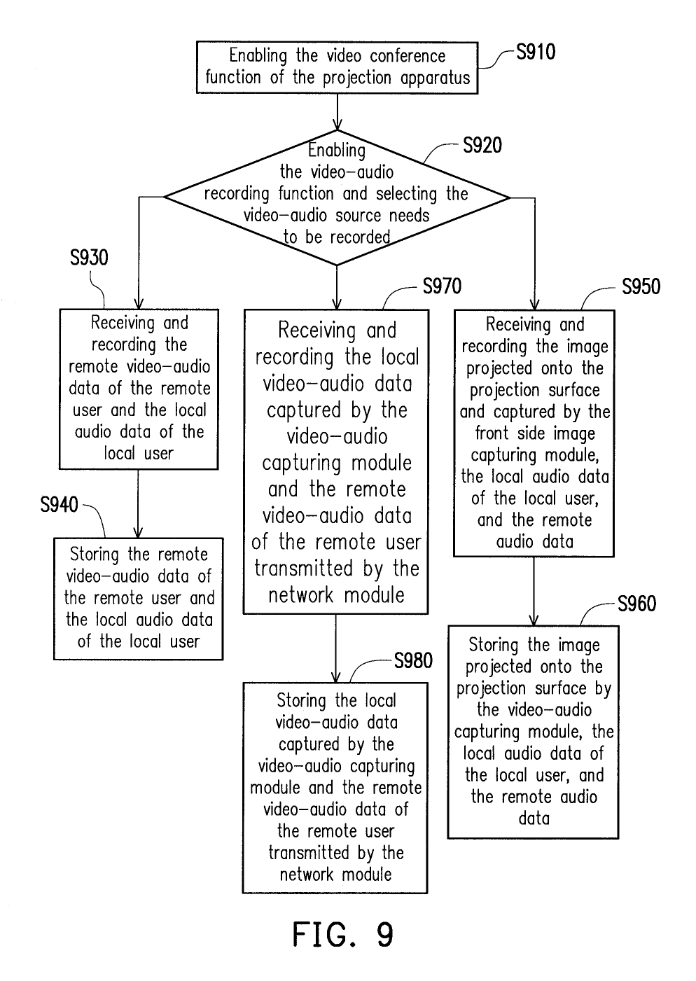

FIG. 9 is a flowchart of the steps in a method of performing video-audio recording using a projection apparatus in another embodiment of the disclosure. The method described herein is adaptable for the projection apparatuses 100-3, 100-4, and 100-5 described in the embodiments in FIGS. 5A-5C. Referring to FIG. 9, in the embodiment, first of all, the video conference function of the projection apparatus is enabled (step S910). Thereafter, the processor 150 enables the video-audio recording function of the video-audio recording module 170 and selects the video-audio source needed to be recorded according to the setting of the local user (step S920). At this time, there are at least three options for selecting the video-audio source. For example, the video-audio recording module 170 receives the remote video-audio data D_AVR of the remote user transmitted via the network module 130 and the local audio data D_AL captured by the audio capturing module and further records them (step S930), and then uses the storage module 180 to store the recorded remote video-audio data of the remote user and the local audio data D_AL (step S920). An alternative option is that, after receiving the image (projected image) projected onto the projection surface and captured by the front side capturing module, the local audio data captured by the audio capturing module, and the remote audio data outputted by the audio processing module (step S950), the projected image and the audio data are stored in the storage module 180 (step S960). Yet another option is that the local video-audio data and the remote video-audio data of the remote user captured by the video-audio capturing module 120 are received and recorded (step S950), and then the local video-audio data as well as the remote video-audio data are stored in the storage module 180 (step S960). In other embodiments, the method of performing video-audio recording by the projection apparatus does not necessarily have the foregoing options; that is, the projection apparatus may have one of the video-audio recording methods only.

In other embodiments, the projection apparatus shows a screen for the user to select a projection function after being turned on; for example, a figure or text indicating the video conference function or general projection operation, is shown for the user to select either one (i.e. receiving the image or video data from the I/O port). When the user selects the figure or text indicating the video conference function, the projection apparatus projects a user log-in screen, and the user can enter the user's identity via the input apparatus and/or an on screen display keypad so as to perform the authentication procedure with the first server.

Based on the aforementioned, the embodiments of the disclosure provide a projection apparatus with a video conference function and a method of performing a video conference using the projection apparatus. The projection apparatus incorporates the network and a video-audio capturing function therein so that a local user can directly perform the video conference with a remote user via the projection apparatus. The projection apparatus is capable of establishing an operation environment for the video conference without a complicated accessories-assembling process, and the image displayed by the projection apparatus is not restricted to the size and specification of displays, thereby providing the user with more convenience and mobility. Additionally, in the embodiments, the conference content can be recorded in a storage module via a video-audio recording module to be read or reviewed in the future.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims. In addition, the language, such as “first” and “second” mentioned in the specification or claims are only intended to name elements or discriminate different embodiments or scopes, and are not intended to limit an upper limit or a lower limit of the number of the elements.

What is claimed is:

1. A projection apparatus with a video conference function, comprising:
a projection module;
a network module, providing a network interface;
a video-audio capturing module, electrically connected to the network module and configured to capture an image and voice of a local user, and accordingly generating a local video-audio data;
a conference module, providing the video conference function; and
a processor, electrically connected to the projection module, the network module, the video-audio capturing module and the conference module,
wherein when the processor enables the video conference function of the conference module, the projection apparatus establishes a connection to a remote apparatus via the network interface, thereby receiving a remote video-audio data of a remote user from the remote apparatus and transmitting the local video-audio data to the remote apparatus,
wherein the projection module is controlled by the processor so as to project an image corresponding to the remote video-audio data onto a projection surface.

2. The projection apparatus with the video conference function according to claim 1, wherein the local video-audio data comprises a local video data and a local audio data, and the remote video-audio data comprises a remote video data and a remote audio data.

3. The projection apparatus with the video conference function according to claim 2, further comprising:
an image processing module, electrically connected to the processor, for performing an image processing to at least one of the local video data and the remote video data; and
an audio processing module, electrically connected to the processor, for performing an audio processing to the remote audio data.

4. The projection apparatus with the video conference function according to claim 3, wherein the projection module projects an image beam onto the projection surface according to the remote video data processed by the image processing module.

5. The projection apparatus with the video conference function according to claim 3, wherein the image processing module blends the local video data and the remote video data to an integrated image, and the projection module projects the integrated image onto the projection surface.

6. The projection apparatus with the video conference function according to claim 3, further comprising:
an audio output module, electrically connected to the audio processing module, for transforming the remote audio data after being processed into a voice output.

7. The projection apparatus with the video conference function according to claim 3, wherein the projection apparatus further comprises: a video processing module, electrically connected to the network module and the image processing module, for transforming the remote video data into a format projectable by the projection apparatus.

8. The projection apparatus with the video conference function according to claim 3, wherein the image processing module is included in the processor.

9. The projection apparatus with the video conference function according to claim 3, wherein the conference module comprises a memory, and the memory comprises a communication software, and the processor enables the video conference function by executing the communication software.

10. The projection apparatus with the video conference function according to claim 9, wherein the projection apparatus further comprises:
a video decompression module, electrically connected to the conference module and the network module, for performing the image processing to the remote video data, and then outputting the processed remote video data to the conference module; and
an audio decompression module, electrically connected to the conference module and the network module, for performing the audio processing to the remote audio data, and then outputting the processed remote audio data to the conference module.

11. The projection apparatus with the video conference function according to claim 10, wherein the video decompression module and the audio decompression module are included in the conference module.

12. The projection apparatus with the video conference function according to claim 9, wherein the projection apparatus further comprises:
a video processing module, electrically connected to the image processing module;
a video decompressing module, electrically connected to the video processing module and the network module, for performing the image processing to the remote video data, and then outputting the processed remote video data to the video processing module; and
an audio decompression module, electrically connected to the audio processing module and the network module, for performing the audio processing to the remote audio data, and then outputting the processed remote audio data to the audio processing module.

13. The projection apparatus with the video conference function according to claim 1, wherein the local video-audio data comprises a local video data and a local audio data, and the video-audio capturing module comprises:
an image capturing module, configured to capture the image of the local user, and generating the local video data accordingly; and
an audio capturing module, configured to capture the voice of the local user, and generating the local audio data accordingly.

14. The projection apparatus with the video conference function according to claim 13, wherein the image capturing module has a 90-degree or greater field of view.

15. The projection apparatus with the video conference function according to claim 13, further comprising a supplemented light source disposed adjacent to the image capturing module and configured to compensate light insufficient for the local user.

16. The projection apparatus with the video conference function according to claim 13, wherein the projection apparatus further comprises a casing which has a front side, a rear side, and a top side, the projection module projects an image beam onto the projection surface, wherein the image capturing module is disposed at one of the rear side and the top side, and an image capturing direction of the image capturing module is opposite to an image projection direction of the projection module.

17. The projection apparatus with the video conference function according to claim 16, wherein the top side has a trench in which the image capturing module is suitable for being accommodated.

18. The projection apparatus with the video conference function according to claim 16, wherein the remote video-audio data comprises a remote video data and a remote audio data, and the projection apparatus further comprises:
an audio processing module, electrically connected to the processor, for performing an audio processing to the remote audio data;
a front side image capturing module, disposed at the front side of the casing and electrically connected to the processor, for capturing an image projected onto the projection surface;
a video-audio recording module, electrically connected to the processor, the front side image capturing module, the audio capturing module and the audio processing module; and
a storage module, electrically connected to the video-audio recording module,
wherein the video-audio recording module records the image projected onto the projection surface, the remote audio data and the local audio data, and stores the image on the projection surface, the remote audio data and the local audio data in the storage module.

19. The projection apparatus with the video conference function according to claim 13, wherein the video-audio capturing module further comprises:
a video compression module, electrically connected to the image capturing module and the network module, for performing an image processing to the local video data, and then outputting the processed local video data to the network module; and
an audio compression module, electrically connected to the audio capturing module and the network module, for performing an audio processing to the local audio data, and then outputting the processed local audio data to the network module.

20. The projection apparatus with the video conference function according to claim 1, wherein the conference module comprises a memory which comprises a communication software, and the processor enables the video conference function by executing the communication software.

21. The projection apparatus with the video conference function according to claim 20, wherein when the communication software is executed, the projection apparatus is connected to a first server via the network interface to perform an authentication procedure, when the authentication procedure is approved, the communication software provides the local user with a permission to send a request for video conference to the remote user, when the local user sends the request for video conference, the processor enables the video-audio capturing module, when the remote user confirms the request for video conference, the communication software establishes a connection between the projection apparatus and the remote apparatus on the first server, and when the remote user confirms the request for video conference, the communication software establishes a connection between the projection apparatus and the remote apparatus on a second server.

22. The projection apparatus with the video conference function according to claim 1, further comprising one of an input apparatus and an on-screen display control interface.

23. The projection apparatus with the video conference function according to claim 1, wherein the local video-audio data comprises a local video data and a local audio data, and the projection apparatus further comprises a video-audio recording module and a storage module, wherein the video-audio recording module is electrically connected to the processor for recording the local audio data and the remote video-audio data, and storing the local audio data and the remote video-audio data in the storage module, wherein the storage module is electrically connected to the video-audio recording module.

24. The projection apparatus with the video conference function according to claim 1, wherein the local video-audio data comprises a local video data and a local audio data, and the projection apparatus further comprises a video-audio recording module and a storage module, wherein the video-audio recording module is electrically connected to the conference module for recording the remote video-audio data and the local video data, and storing the remote video-audio data and the local audio data in the storage module, wherein the storage module is electrically connected to the video-audio recording module.

25. The projection apparatus with the video conference function according to claim 1, wherein the network interface comprises at least one of a wired network interface and a wireless network interface.

26. A method of performing a video conference using a projection apparatus, comprising:
enabling a video conference function of the projection apparatus;
capturing an image and voice of a local user, and accordingly generating a local video-audio data;
establishing a connection to a remote apparatus via a network interface;
receiving a remote video-audio data of a remote user from the remote apparatus, and transmitting the local video-audio data to the remote apparatus; and
projecting an image corresponding to the remote video-audio data onto a projection surface.

27. The method of performing the video conference using the projection apparatus according to claim 26, wherein the local video-audio data comprises a local video data and a local audio data, and steps of capturing the image and voice of the local user and generating the local video-audio data accordingly comprise:
capturing the image of the local user, and accordingly generating the local video data; and
capturing the voice of the local user, and accordingly generating the local audio data.

28. The method of performing the video conference using the projection apparatus according to claim 26, wherein the local video-audio data comprises a local video data and a local audio data, and the remote video-audio data comprises a remote video data and a remote audio data, further comprising steps of:
performing an image processing to at least one of the local video data and the remote video data; and
performing an audio processing to at least one of the local audio data and the remote audio data.

29. The method of performing the video conference using the projection apparatus according to claim 28, further comprising a step of:
projecting an image of the remote user onto the projection surface according to the remote video data after being processed.

30. The method of performing the video conference using the projection apparatus according to claim 28, further comprising a step of:
projecting an integrated image onto the projection surface according to the local video data and the remote video data both after being processed.

31. The method of performing the video conference using the projection apparatus according to claim 28, further comprising a step of:
transforming the remote audio data after being processed into a voice output.

32. The method of performing the video conference using the projection apparatus according to claim 26, wherein the step of enabling the video conference function of the projection apparatus comprises:
executing a communication software;
connecting to a first server via the network interface;
performing an authentication procedure;
determining whether the authentication procedure is approved; and
when the authentication procedure is approved, providing the local user with a permission to send a request for video conference to the remote user.

33. The method of performing the video conference using the projection apparatus according to claim 32, wherein after the authentication procedure is approved, the step of enabling the video conference function of the projection apparatus further comprises:
determining whether the local user sends the request for video conference;
when the local user sends the request for video conference, starting to capture the image and voice of the local user, and determining whether the remote user confirms the request for video conference; and
when the remote user confirms the request for video conference, establishing the connection between the projection apparatus and the remote apparatus on the first server.

34. The method of performing the video conference using the projection apparatus according to claim 32, wherein after the authentication procedure is approved, the step of enabling the video conference function of the projection apparatus further comprises:
determining whether the local user sends the request for video conference;
when the local user sends the request for video conference, starting to capture the image and voice of the local user, and determining whether the remote user confirms the request for video conference; and
when the remote user confirms the request for video conference, establishing the connection between the projection apparatus and the remote apparatus on a second server.

35. The method of performing the video conference using the projection apparatus according to claim 26, wherein after the video conference function of the projection apparatus is enabled, enabling a video-audio recording function.

36. The method of performing the video conference using the projection apparatus according to claim 35, wherein the local video-audio data comprises a local video data and a local audio data, further comprising steps of:
receiving and recording the remote video-audio data of the remote user transmitted by a network module and the local audio data, and storing the remote video-audio data of the remote user and the local audio data.

37. The method of performing the video conference using the projection apparatus according to claim 35, wherein the local video-audio data comprises a local video data and a local audio data, and the remote video-audio data comprises a remote video data and a remote audio data, further comprising steps of:
after receiving an image projected onto the projection surface and captured by a front side image capturing module, the local audio data captured by an audio capturing module, and the remote audio data outputted by an audio processing module, storing the projected image, the local audio data and the remote audio data in the storage module.

38. The method of performing the video conference using the projection apparatus according to claim 35, further comprising steps of:
receiving and recording the local video-audio data of the local user captured by a video-audio capturing module and the remote video-audio data of the remote user transmitted by a network module, and storing the local video-audio data and the remote video-audio data.
